(19) United States
(12) Patent Application Publication
(10) Pub. No.: US 2002/0034291 A1
(43) Pub. Date: Mar. 21, 2002

(54) Communication network and method for installing the same

(76) Inventors: James A. Pope, Haskell, OK (US); Ann Kruse, Somerset, NJ (US); Marvin Young, Richardson, TX (US)

Correspondence Address: WORLDCOM, INC., TECHNOLOGY LAW DEPARTMENT, 1133 19TH STREET NW, WASHINGTON, DC, 20036, US

(21) Appl. No.: 09/825,391

(22) Filed: Apr. 3, 2001

Related U.S. Application Data
(60) Provisional application No. 60/194,233, filed on Apr. 3, 2000.

(51) Int. Cl. H04M 7/00

(52) U.S. Cl. 379/219

(57) ABSTRACT

Disclosed is a three-cable communication network that terminates at four separate landing sites on two separate landmasses, the network carrying four grades of traffic, with the lowest grade of traffic being preempted upon failure. Switching elements that terminate the cables at each landing site and switching logic by which the various grades of traffic are routed in response to failure scenarios, is also disclosed. Also set forth is a method of installing the aforementioned three-cable communication network that includes the steps of laying a first cable of bandwidth X between a landing site on each landmass, then laying a second cable, also of bandwidth X, between two other landing sites on each landmass. A third joined cable of at least bandwidth 2X having four ends is then laid between the sites on the two landmasses with one end connecting to each landing site, and connecting at least bandwidth X to each landing site.

### CROSS-REFERENCES TO RELATED APPLICATIONS

This application is related to, and claims the benefit of the earlier filing date of U.S. Provisional Patent Application No. 60/194,233, filed Apr. 3, 2000, entitled “Multiple Cable Transoceanic Communications System and Method for Deployment Thereof,” the entirety of which is incorporated herein by reference.

### BACKGROUND OF THE INVENTION

1. Field of the Invention

The present invention relates to a transoceanic cable communications system and more particularly to a system and method for installing a communication network.

2. Description of the Related Art

One form of transoceanic communications involves laying cable, containing electrical conductors or optical fibers, along the ocean floor and terminating the cable at equipment sites on land at either end of the cable. The reliability of a transoceanic communications system is often improved by using two cables terminating at different points on each landmass. This provides some spatial diversity so that a cable cut or equipment malfunction affecting one cable is unlikely to affect the other cable.

A 1:1 traffic protection ratio is normally required. This level of redundancy is necessary because the failure of one cable operating at maximum bandwidth necessarily requires the entirety of another cable to restore all of the traffic. Thus, the costs of installing and maintaining a system of a given bandwidth are increased because of the required level of redundancy.

Furthermore, at each landmass, the pairs of landing sites are linked to one another so that traffic may be diverted or switched at either end of the overall link to circumvent failures. In some arrangements, the combination of the two undersea cables and the two land-land connections are treated as a line switched ring to accomplish fast and simple protective switching.

FIG. 1 of the accompanying drawings illustrates a traditional transoceanic cable system comprising two separate cables. Optical fiber cables 170 and 172 are shown spanning across an ocean 102, but can span any region that presents economical or physical constraints in its construction and/or maintenance. A cable buried deep under the ocean is inaccessible, but nevertheless is subject to failure. In this context, it is impractical to erect, and provide power to, a network of equipment sites along the cable to permit, for example, a diversely routed mesh structure to be formed out at sea that would improve the robustness of the transoceanic span. A similar situation is foreseen where communications are attempted from one region to another region through intervening air or space, or spanning hostile environments or large undeveloped areas such as jungles, forests, mountains or deserts. The intervening area to be spanned may be in political unrest, such as a combat zone or an otherwise sensitive area, thus preventing even routine maintenance.

The information cables themselves may take the form of electrical or optical cables or may be a radio frequency communication path. In all of these instances, reliable communications may be achieved through redundant but diversely routed spans to make up for the relative inaccessibility of the long spans. A well-known ring structure is used in each region to provide landing site diversity and the interconnections between the rings are expressly provided for the purpose of spanning a lengthy inaccessible intervening region.

Referring again to FIG. 1, the span provides communications between landmass A and landmass B. Upon failure of either cable 170 or 172 due to damage or equipment failure, the transoceanic connection is readily restored using the other cable to circumvent the failure through the use of protective switching schemes. A well-known self-healing ring design can be employed to facilitate this protective switching. This is accomplished by providing two additional fiber spans 174 and 176 between each pair of on-land terminating points of cable 170 and 172, that is, between sites 144 and 146, and 152 and 158, respectively. Using an Add-Drop Multiplexer (ADM) at each terminating point, this arrangement forms a self-healing ring structure, such as a bi-directional line switched ring, the design and operation of which is well documented and understood among those of ordinary skill in the art.

Furthermore, to provide some protection against terrestrial failures and to make terrestrial and submarine failures independent of one another, so-called “backhaul rings” are used at both terrestrial ends to couple traffic to the transoceanic ring. In FIG. 1 one such backhaul ring is shown comprising sites 142, 144, 146, and 148 as interconnected by a series of links or cables. The links are cables, optical fibers, wireless systems, or the like. Span 190, comprised of two cables 162 and 174, also referred to as an “interlink” span, traditionally comprises one link that is part of a transoceanic ring (e.g. cable 174) and one link that is part of the backhaul ring (e.g. cable 162). The transoceanic ring is formed by cables 170 and 172, sites 144, 152, 158, and 146, and interlink spans 190 and 192 (more particularly, cables 174 and 176) on landmasses A and B. The net result is a three-ring structure with two nodes of each backhaul ring coupled to two nodes of the transoceanic ring.

A node or site is a point along a ring where traffic may be added, dropped, or merely passed along, usually via an ADM. In some cases, a node may also comprise passive optical switches when fiber optic technology is implemented. The nodes have two or three input/output ports depending on its particular use in the ring structure. For example, as shown in FIG. 2, node 148 is a 2-port node; data enters into ADM 118 and is passed along to ADM 116 of node 146. The other 2-port node shown in FIG. 2 is node 154. In contrast, node 142 is a 3-port node containing ADM 112. Data enters into ADM 112 of node 142 via input ports 180, and depending on the switch configuration of ADM 112, the data can be transmitted to node 144 or node 148. The other 3-port nodes shown in FIG. 2 are nodes 144, 146, 152, 156 and 158.

At each site where a terrestrial backhaul node adjoins a transoceanic node (i.e., nodes 144, 146, 152 and 158), the traffic is dropped from one ADM at a tributary rate and enters an adjoining node ADM at the tributary rate. The term “tributary” means that the data rate along a cable is a fraction of the aggregate rate that is actually transmitted over the cable. For example, if an OC-192 optical signal is transmitted at 10 gigabits-per-second is received by ADM 114 it may be multiplexed into four tributary data streams of about 2.5 gigabits-per-second, each stream transmitted across a connection of link 164. As shown in FIG. 2, tributary connection 164 carries data extracted by ADM 114 from backhaul ring 110 and passes the extracted data to ADM 124 to be carried by transoceanic ring 120.

The following is an example of data communications under normal circumstances in the traditional three-ring network architecture depicted in FIG. 2. Information to be communicated is submitted along data inputs 180 and enters backhaul ring 110 through ADM 112 of node 142. The information proceeds along cable 160 to node 144, wherein ADM 114 passes the data to ADM 124 over tributary connection(s) 164. The data is sent along transoceanic cable 170 to reach ADM 122 of node 152. At ADM 122 the information is “dropped” from transoceanic ring 120 and coupled into backhaul ring 130 via ADM 132. The information travels through cable 180 of backhaul ring 130 via ADM 134 of node 154, through cable 182, and reaches its destination at ADM 136 of node 156 where it is delivered at output ports 182. As shown in FIG. 2 and as described above, the dashed line throughout the figures depicts the routing path of the data. Also shown in FIG. 2 are ADM 126, ADM 128, ADM 138, and cables 161, 171, 188 and 184.

Table 1 lists the standard bandwidth (“BW”) carried on each cable and the protection schemes available during installation of the traditional three-ring network.

TABLE 1

| Cable | Band Width (Tbps) | Protection Schemes Offered |
|---|---|---|
| 1 | 5.12 | Unprotected |
| 2 | 5.12 | Ring, Best Effort |

The bandwidths shown are examples only and not intended to limit the scope of the invention. Each cable is shown to be carrying 5.12 Tbps. Table 1 indicates that the first cable which is typically installed during the first year of operation will be unprotected. This means that it may carry traffic during the first year but if the cable is severed, all traffic will be cut off without remedy. Table 1 further indicates that after the second cable is installed, usually during the second year, a ring structure or similar protected arrangement can be formed so that damage to one cable may be circumvented by using the other cable and traffic flow will be maintained.

FIG. 3 depicts a prior art variation also utilizing two deep-sea cables 311-312, but using three landing sites (not shown) on each landmass and a number of shallow-water cables 301-308 that are heavily protected to resist damage. This “double split” design is motivated by the higher incidence of cable failures at shallow depths. Shallow portions of a cable are inherently more susceptible to damage due to wave action and other natural phenomena, as well as man-made causes such as boat traffic and construction work. The double split configuration utilizes two deep-sea cables 311-312, each cable having four ends or shallow water cables 301-308. Each end of the shallow water cable is connected to a landing site with one landing site on each landmass connected to a second end. Each end carries a percentage of the total bandwidth of the cable. Referring again to FIG. 3 an even percentage, i.e. 2.56 Tbps, is distributed over each end. This results in one site on each landmass connected to two ends carrying a total of 5.12 (2.56+2.56) Tbps. The percentages shown can vary depending on the design of the system.

Table 2 lists the standard bandwidth (“BW”) carried on each cable and the protection schemes available during installation of the double split design.

TABLE 2

| Cable | Band Width (Tbps) | Protection Schemes Offered |
|---|---|---|
| 1 | 5.12 | Shallow Protected |
| 2 | 5.12 | Ring, Best Effort, Multigrade |

Table 2 indicates that each cable carries a bandwidth of 5.12 Tbps. Table 2 also indicates that the first cable installed during the first year will be protected in the shallow end. This means that the main cable may carry traffic during the first year. If one end is severed, that leg's traffic can be rerouted through the other shallow leg. But if the main cable is severed, all traffic will be cut off without remedy. Table 2 further indicates that after the second cable is installed during the second year, a ring structure or similar protective switching arrangement can be implemented to maintain traffic flow in the event of a failure of one cable by using the other cable.

These arrangements of ADMs and cables to form adjoining rings are shown to be robust against many site outages, tributary failures, terrestrial span outages, transoceanic span outages, and combinations thereof. Several terms are used throughout the industry to describe this common configuration, including “matched-node configuration”, “dual ring interconnect”, and “dual junction”. There are also existing mechanisms and protocols, such as standardized Alarm Indication Signals (AIS) or Automatic Protect Switching (APS) schemes (e.g. K1/K2 bytes in SONET overhead), by which ADMs may be informed of failed connections by other ADMs.

The offering of various grades of service, corresponding to availability levels, gives the owner of such a transoceanic communications facility the ability to partition traffic based upon importance and to offer various rate plans to customers based upon their desire for a reliable connection. As used herein, the grades of service are either single-grade or multi-grade. A single-grade service is one where all traffic is assessed with equal importance. In a multi-grade system at least one part of the traffic is given greater importance than other traffic. This grade “level” approach makes use of the full available bandwidth of the cables at all times. Among populations of communications customers, it is often the case that some communication needs are critical where others are non-essential. While one customer, such as the stock market trading floor for a large country, may truly need and be willing to pay for a connection that fails only once in 26 years, another customer may desire the lowest cost possible and may tolerate an occasional loss of service every few months. The ability to offer high reliability connection at a premium, as well as other grades of service, is of great advantage to a communications service provider. Many different grades of traffic can coexist on any one given system. FIG. 2 depicts a single grade system, that is, if one cable fails, all of the traffic is switched to the second cable. FIG. 3 depicts a multi-grade system, with grades of service of four possible levels given equal distribution of cable bandwidths.

It is therefore desirable to reduce the initial installation costs and recurring operating costs of a transoceanic system. It is also desirable to reduce the possibilities of data traffic outages due to occasional failures of cables and equipment. A transoceanic cable system that improves utilization of cable bandwidth and reduces installation and maintenance costs per unit bandwidth is also desirable. Furthermore, a system to provide for different grades of service, based on different availability levels depending on how traffic is routed and the average failure rates of the cables, is also desirable.

### SUMMARY OF THE INVENTION

In accordance with the present invention, a communication network and method for installing the same is provided. A first embodiment of the present invention describes a three-cable communication network that terminates at four separate landing sites on two separate landmasses. The present invention teaches a way in which four grades of traffic may be simultaneously carried through this arrangement, with the lowest grade of traffic being preempted upon failure. The highest grade of traffic experiences improved availability over the prior art, and the second highest grade experiences availability comparable to the traditional two-fiber arrangement.

The present invention further teaches switching elements that terminate the cables at each landing site and switching logic by which the various grades of traffic are routed in response to failure scenarios, including multiple cable failure scenarios.

Also part of the present invention is a method of installing the aforementioned three-cable communication network. The sequence of deployment described makes best use of the availability of the higher capacity cable. In summary, a first cable of bandwidth X is laid between a landing site on each landmass. Next, a second cable, also of bandwidth X, is laid between two other landing sites on each landmass. A third joined cable of at least bandwidth 2X having four ends is laid between the sites on the two landmasses with one end connecting to each landing site, and connecting at least bandwidth X to each landing site. The joined cable is either two cables laid side by side or a single sheathed cable having at least twice the capacity X.

### BRIEF DESCRIPTION OF THE DRAWINGS

The above and other objects, features and advantages of the present invention will become more apparent from the following detailed description when taken in conjunction with the accompanying drawings in which:

FIG. 1 is an illustration of the traditional two-cable transoceanic system;

FIG. 2 is a detailed illustration of the traditional two-cable system of FIG. 1;

FIG. 3 is an illustration of the traditional double-split configuration two-cable system;

FIG. 4 is an illustration of a communication network according to a preferred embodiment of the present invention;

FIG. 5 is an illustration of a communication network according to the preferred embodiment of the present invention depicting the bandwidth of each cable;

FIG. 6 is an illustration of a communication network according to the preferred embodiment depicting the flow of traffic of four grades of traffic under normal operating conditions;

FIG. 7 through FIG. 9 are illustrations of a communication network according to the preferred embodiment of the present invention depicting various single cable failures;

FIG. 10 through FIG. 12 are illustrations of a communication network according to the preferred embodiment of the present invention depicting various double cable failures;

FIG. 13 is an illustration of a communication network according to the preferred embodiment of the present invention depicting a three-cable failure;

FIG. 14 is an illustration of a landing site switching element used in the preferred embodiment of the present invention; and

FIG. 15 is an illustration of a communication network according to the preferred embodiment of the present invention with reference to the switching element of FIG. 14.

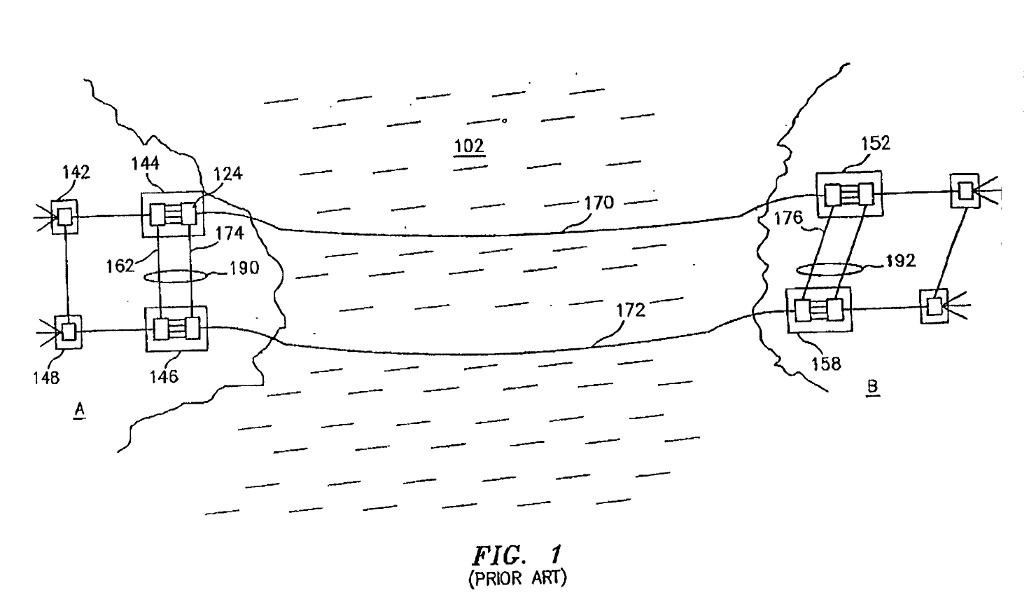

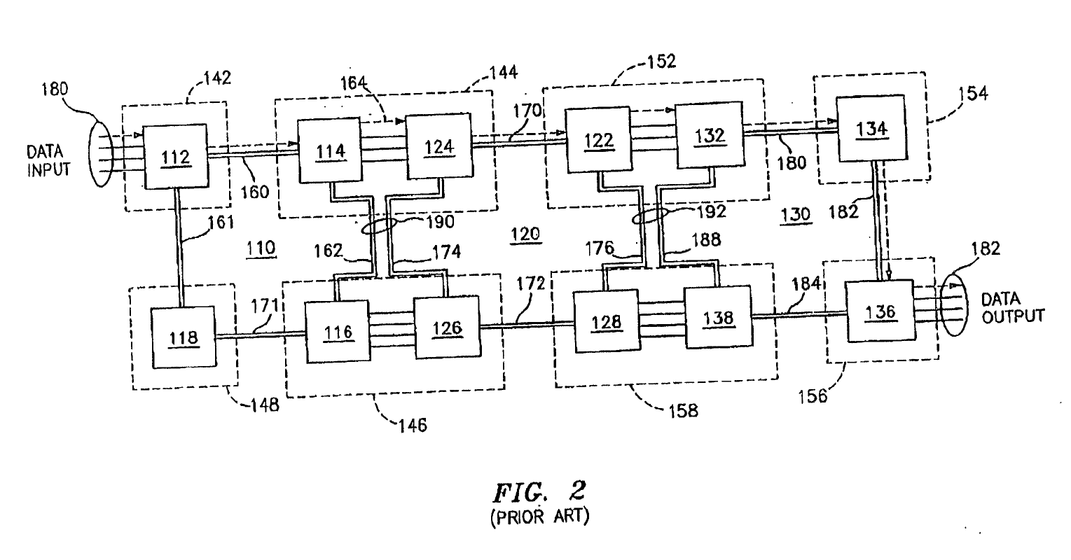

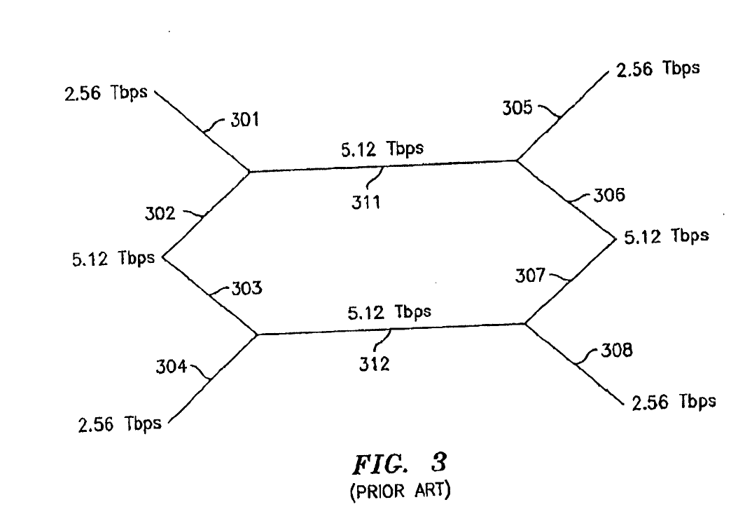

### DETAILED DESCRIPTION OF PREFERRED EMBODIMENTS

A preferred embodiment of the present invention will be described in detail herein below with reference to the accompanying drawings. In the following description, numerous specific details are set forth to provide a more thorough understanding of the present invention. It will be apparent, however, to one skilled in the art that the present invention may be practiced without these specific details. In other instances, well known functions or constructions have not been described so as not to obscure the present invention.

Given the cost of installing and maintaining a transoceanic cable or fiber optic communications link, there is a desire to carry as much bandwidth as possible in each fiber or each cable that is laid undersea. Furthermore, because a transoceanic link is a crucial channel for commerce and a significant revenue stream for the owner of the link, the availability of the link is extremely important. Because cable failures do occur fairly often and are difficult to repair, it is common practice to provide redundancy in both the number of cables laid and the locations of landing sites at either end of the link.

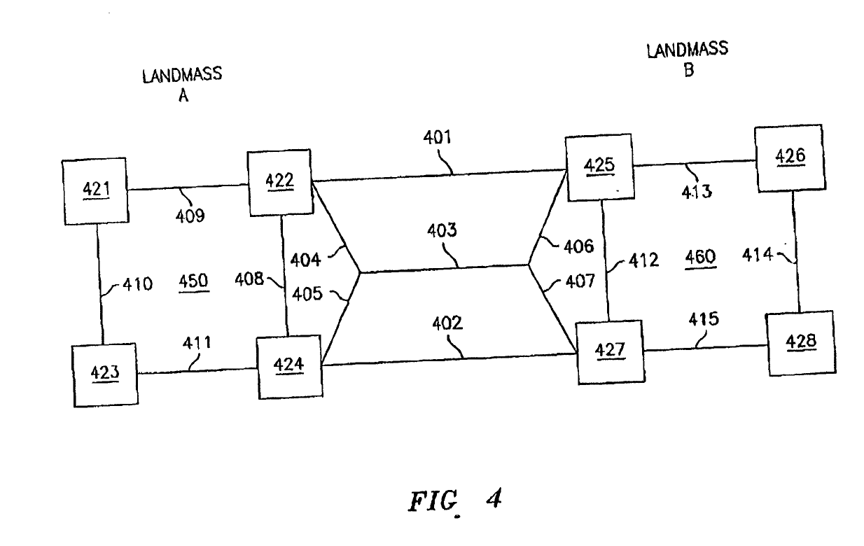

FIG. 4 of the drawings depicts a communications network according to a preferred embodiment of the present invention whereby three deep-sea cables 401-403 are coupled to four of the landing sites 422, 424, 425 and 427, two on each landmass A and B. This configuration affords high bandwidth, multiple availability levels, and cost effective deployment. The highest availability level in this configuration is roughly an order of magnitude greater than that of the traditional two-cable configurations. Shallow, heavily protected cables 404, 405, 406 and 407 are used between the deep-sea cables 401, 402 and 403 and the landing sites 422, 424, 425, and 427. Interconnecting cables 809-411 and 412-415 are also shown.

Also shown in FIG. 4 are backhaul ring 450 and backhaul ring 460, similar to that of existing three-ring structures. The three cables 401, 402 and 403 are shown along with four cable legs 404, 405, 406 and 407. Cable 403 can be a single cable that is “split terminated” to form the four cable legs. Alternatively, cable 403 can be two separate cables each having two ends. Cable 401 connects node 422 to node 425. Cable 402 connects node 424 to node 427. Cable 403 connects node 422 to node 425 and also connects node 424 to node 427. With this cable configuration, four grades of traffic can be offered if equal bandwidth is allocated on cable 401 and cable 402 and at least twice that bandwidth carried on cable 403.

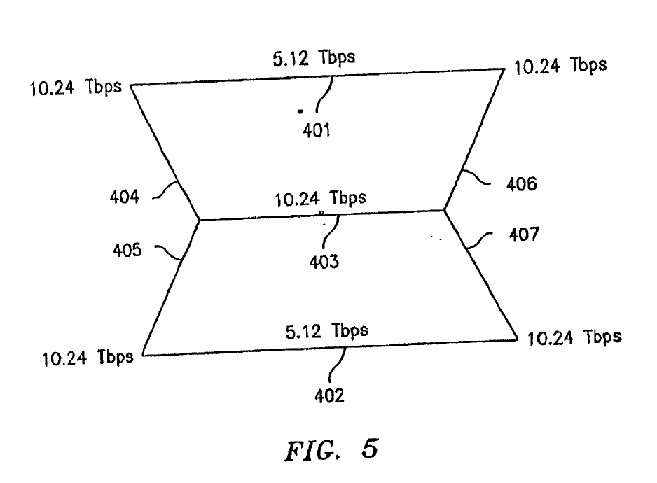

FIG. 5 details the maximum bandwidth capacity of each cable in the preferred embodiment of the present invention. The third cable 403 to be installed and split terminated at either end has twice the capacity of the other two cables 401 and 402, enabling a variety of grades of service and restoration switching schemes. In accordance with the progressive installation of cables described herein, the third cable 403 will naturally have a higher capacity as the technology to achieve higher capacity progresses during the overall duration of installing the system. Cable 401 and cable 402 carry a maximum of 5.12 Tbps and cable 403 carries a maximum of 10.24 Tbps. Cable 403 is either two joined cables of 5.12 Tbps each or one cable of 10.24 Tbps. Each cable leg would therefore carry 5.12 Tbps in the preferred embodiment.

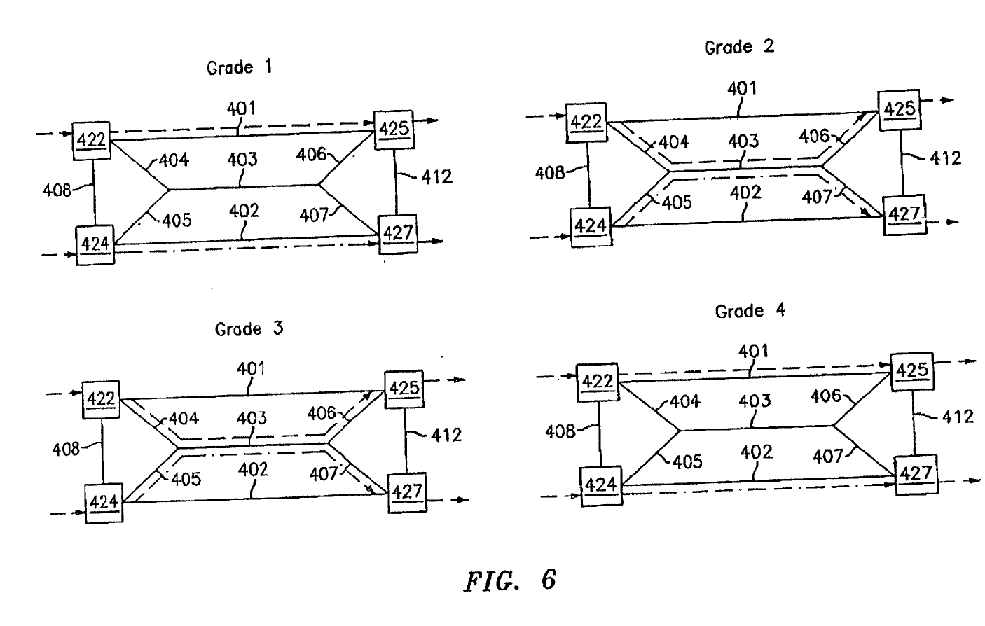

FIG. 6 through FIG. 13 depict the preferred embodiment of the present invention under various operating conditions. Each grade of traffic is transmitted in two parts, each part transmitting equal amounts of data traffic. The grades of traffic are distinguished by the thickness of the dashed lines, the thickest dashed line representing the highest priority grade or Grade 1 traffic, down to the thinnest dashed line representing the lowest priority grade or Grade 4 traffic.

FIG. 6 depicts the traffic flow for the four grades of traffic of the preferred embodiment of the present invention under normal operating conditions. Grade 1 traffic, highest priority grade, transmits through cable 401 from node 422 to node 425 and through cable 402 from node 424 to node 427. Grade 2 traffic, second highest priority grade, transmits through cable leg 404, cable 403 and cable leg 406 from node 422 to node 425 and through cable leg 405, cable 403 and cable leg 407 from node 424 to node 427. Grade 3 traffic, third highest priority grade, following the same path as Grade 2 traffic, transmits through cable leg 404, cable 403 and cable leg 406 from node 422 to node 425 and through cable leg 405, cable 403 and cable leg 407 from node 424 to node 427. Grade 4 traffic, lowest priority grade, following the same path as Grade 1, transmits through cable 401 from node 422 to node 425 and through cable 402 from node 424 to node 427. Under normal operating conditions, all four grades of traffic are transmitted without interruption.

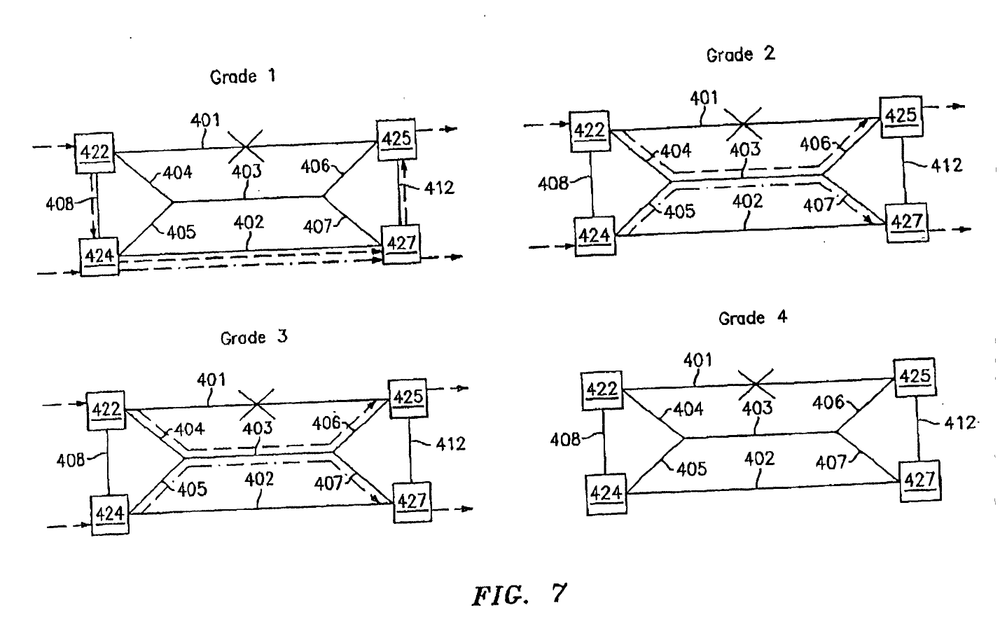

FIG. 7 through FIG. 13 depict the three-cable arrangement under various failure conditions and show the diversion of the various grades of traffic to assure that the higher grades of traffic are given preference in filling the cable bandwidth remaining after the failure.

FIG. 7 depicts a failure of cable 401. In this scenario Grade 1 traffic, having highest priority is rerouted from node 422 to node 424 through cable 402 to node 427 where it is switched to node 425. Therefore, even with a failure of cable 401, all of Grade 1 traffic survives. As Grade 2 traffic is unaffected by the failure of cable 401, it continues to be transmitted along its normal operating path, whereby all of Grade 2 traffic also survives. Similarly, all of Grade 3 traffic also survives since its normal transmission path is uninterrupted. Finally, upon a failure of cable 401, all of Grade 4 traffic (lowest priority) is lost. Normally Grade 4 traffic is transmitted along cable 401 and cable 402, but since cable 401 has failed that part of the Grade 4 traffic cannot be transmitted. Further, since Grade 1 traffic (highest priority) requires cable 402 to avoid loss of its traffic, Grade 1 traffic takes priority over Grade 4 with respect to the use of cable 402.

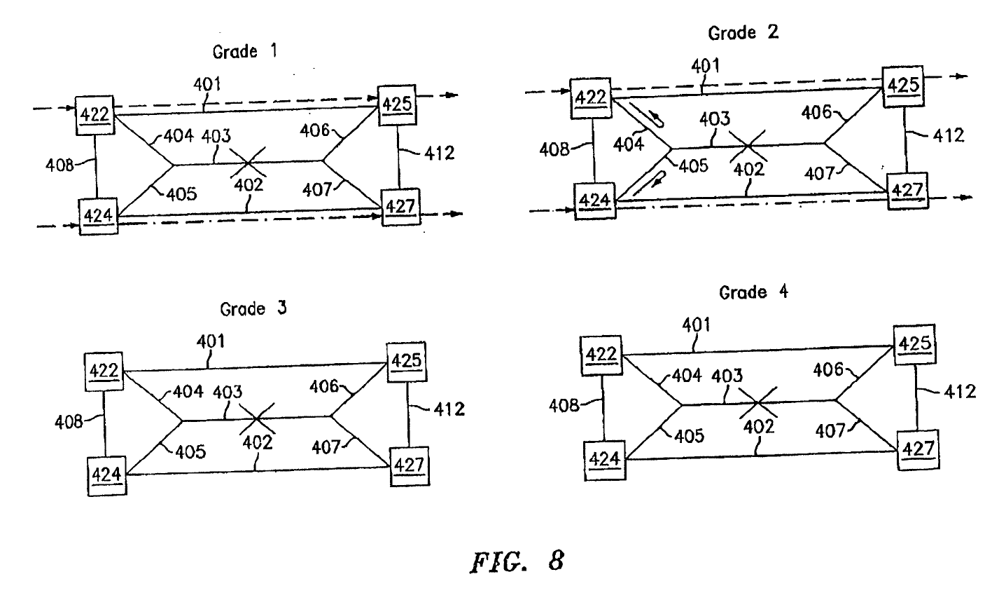

FIG. 8 depicts a scenario when cable 403 suffers a failure. When this occurs, all of Grade 1 traffic is transmitted along its normal path and survives. Grade 2 survives through rerouting through cable 401 and cable 402.The two lowest grades of traffic, Grade 3 and Grade 4, lose all of their traffic since the bandwidth of cable 401 and cable 402 are exhausted by Grade 1 and Grade 2 traffic.

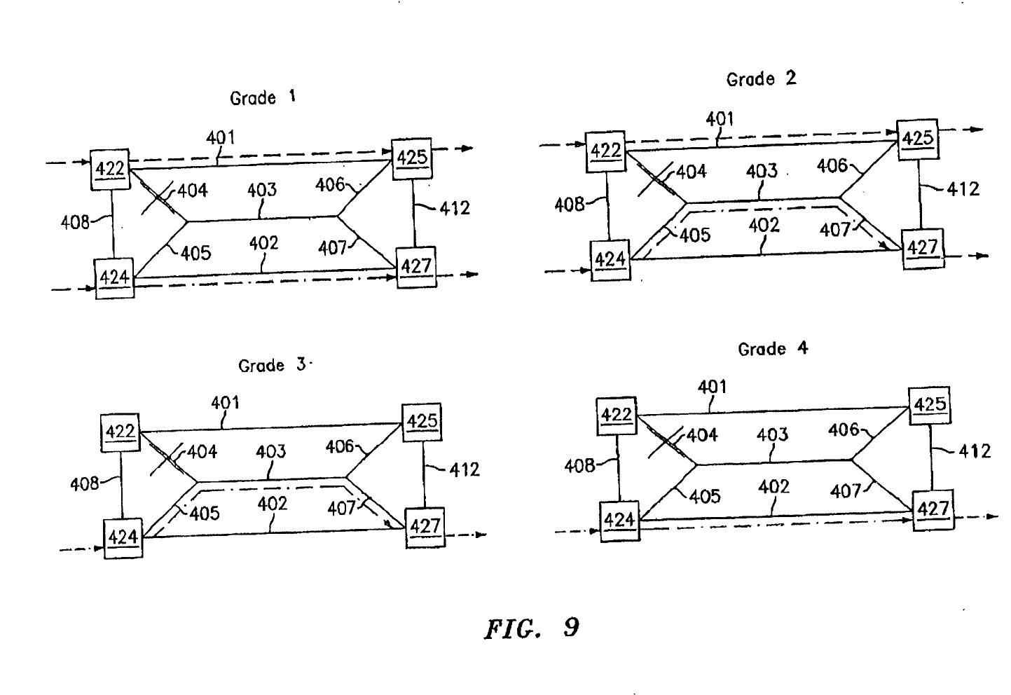

FIG. 9 depicts a failure of cable leg 404. When this scenario occurs all of Grade 1 traffic is transmitted without fault along its normal path. All of Grade 2 traffic is also transmitted but one-half of the traffic needs to be switched to cable 401. With respect to Grade 3 and Grade 4 traffic, two scenarios are possible depending on the switching operations and predetermined operating priorities, in that either Grade 3 and Grade 4 traffic each suffer a loss of one-half of their traffic (as shown in FIG. 9), or the second half of the Grade 3 traffic is switched to cable 402 and all of Grade 4 traffic is lost (not shown).

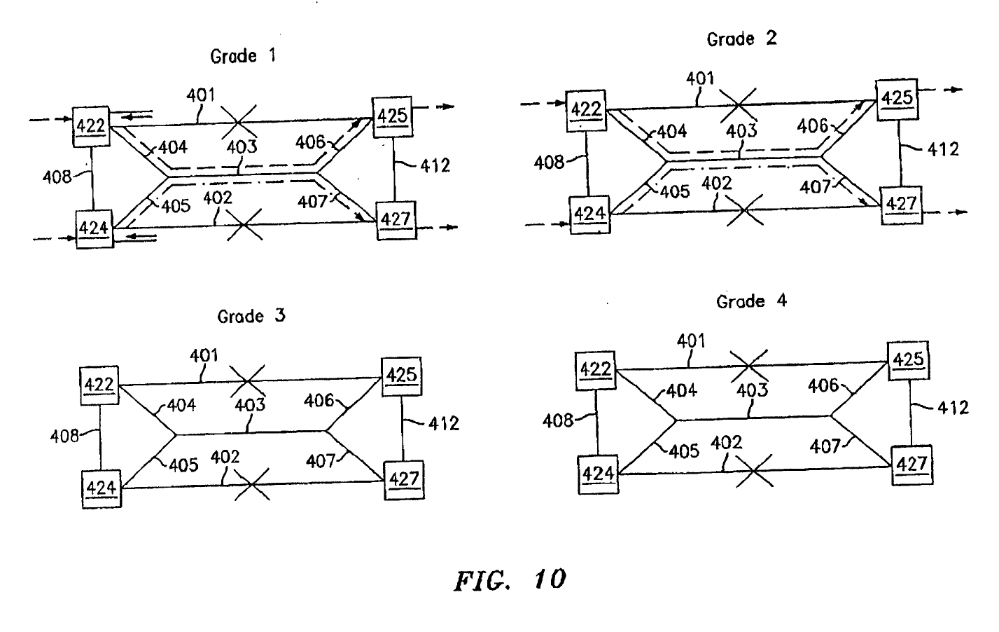

FIG. 10 through FIG. 12 depict scenarios where there is a failure of two cables.

FIG. 10 depicts a dual cable failure of cable 401 and cable 402. When this failure occurs all of Grade 1 traffic is switched onto cable 403 and survives. All of Grade 2 traffic survives on its normal path. All of Grade 3 and Grade 4 traffic is lost since the bandwidth of the remaining cable 403 are exhausted by Grade 1 and Grade 2 traffic.

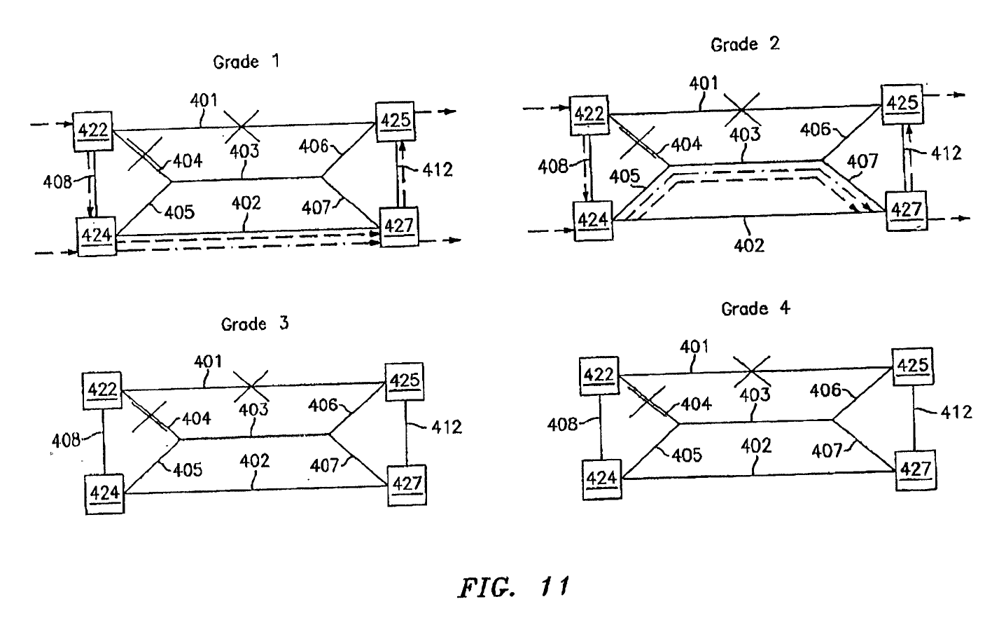

FIG. 11 depicts a failure of cable 401 and cable leg 404. When this failure occurs all of Grade 1 and Grade 2 traffic survives with one-half of each grade being rerouted as shown. Since the bandwidth of each surviving cable is used by higher grades of traffic, all of Grade 3 and Grade 4 traffic is lost.

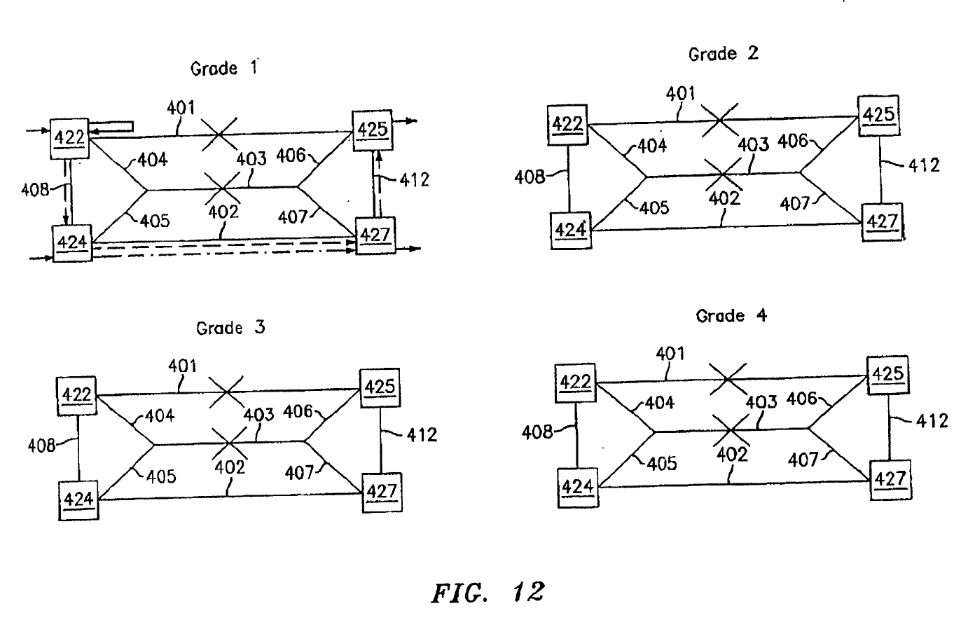

FIG. 12 depicts a failure of cable 401 and cable 403. When this type of failure occurs all of Grade 1 traffic can be rerouted through cable 402 as shown, but none of the lesser grades of traffic can be rerouted and are lost. All of the bandwidth of cable 402 is utilized by Grade 1 traffic.

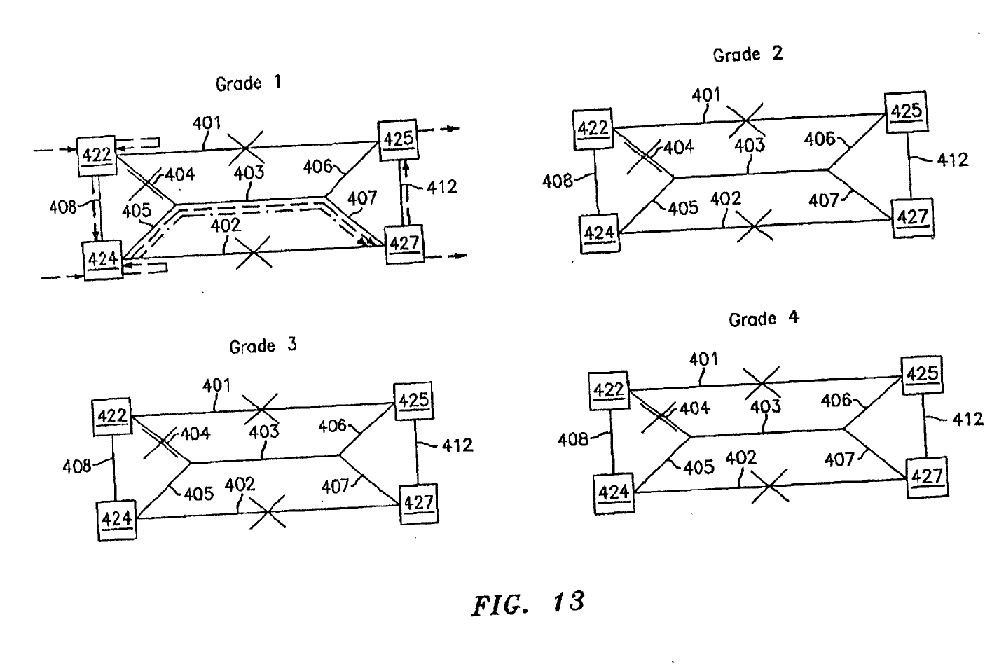

FIG. 13 depicts a failure of three cables, that is, cable 401, cable 402 and cable leg 404. With this type of failure all of Grade 1 traffic is rerouted through cable 403 as shown and survives. Each of the three remaining grades of traffic cannot be rerouted due to the bandwidth limitation of cable 403 and are lost.

As shown be the previous examples, Grade 1 traffic can be rerouted in all of the preceding scenarios and survives each of the failures depicted. It is only when all three main cables (i.e. 401, 402 and 403) fail that Grade 1 traffic is lost. Based on the general failure rates of cables of the current two-cable systems, the mean times between failures (MTBF) of each grade of traffic can be estimated as follows:

MTBF Grade 1:˜26 years

MTBF Grade 2:˜3.5 years

MTBF Grade 3:˜4 months

MTBF Grade 4:˜2 months

Each grade of traffic could be priced according to its MTBF based on the users' needs and for a more trustworthy connection.

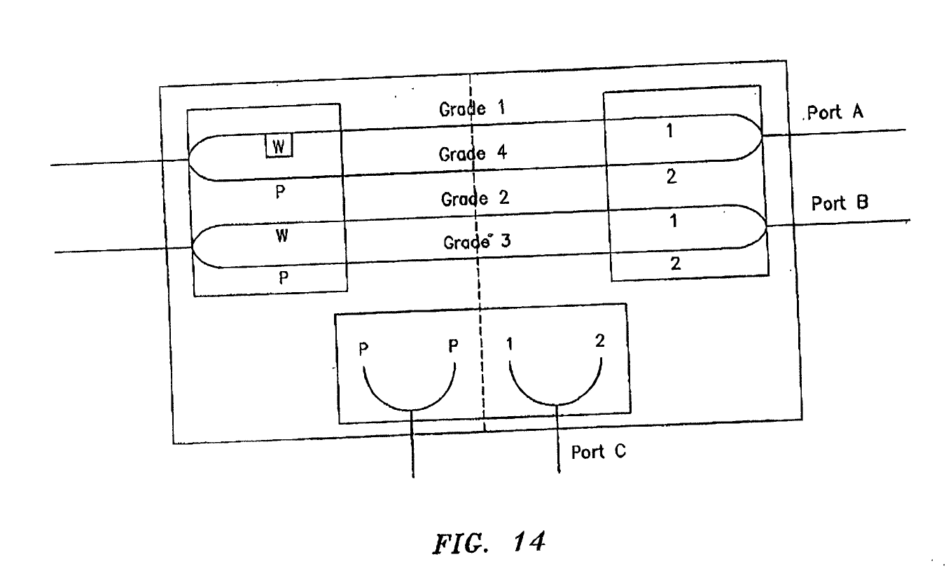

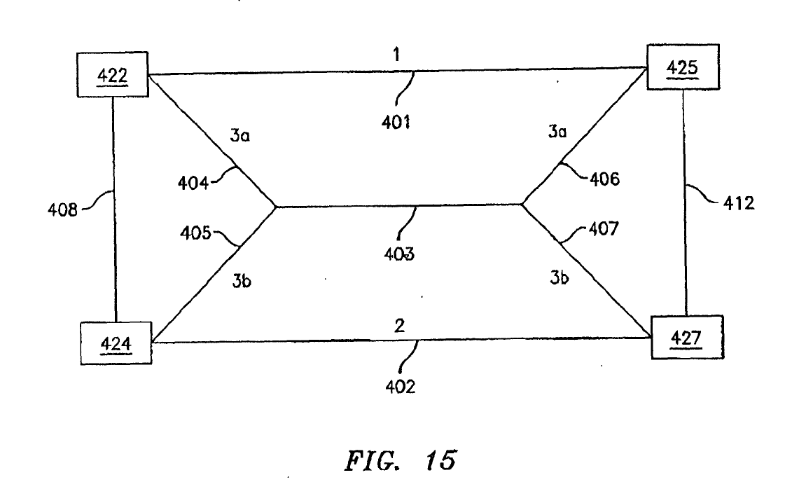

FIG. 14 shows a design for a switching element used at a landing site to accommodate the various grades of service. For proper operation of the preferred embodiment, each switching element of sites 422, 424, 425, and 427 would need at least six interfaces. FIG. 15 depicts the preferred embodiment with reference numbers shown in parentheses. The labels of “1”, “2”, “3a” and “3b” are references used in conjunction with the switching data of Table 3, below. For simplicity, each site contains only one switching element. When the switching element of FIG. 14 is viewed in conjunction with FIG. 15, line 1 and line 2 of Port A is multiplexed onto cable 401, line 1 and line 2 of Port B is multiplexed onto cable leg 404, and line 1 and line 2 of Port C is multiplexed onto link 408. Since Grade 1 and Grade 4 traffic normally flow on cable 401(see 5 FIG. 6), they are connected to Port A. Also, since Grade 2 and Grade 3 traffic normally flow on cable leg 404, they are connected to Port B. Multiplexing allows both grades to be transmitted along a single cable. Port C is used to reroute traffic to site 424 when a failure occurs. With each site containing at least one of the switching elements of FIG. 14, the traffic can be switched as necessary to circumvent the different failure scenarios.

Table 3 lists in Boolean table format the switching logic that may be used in accordance with a preferred embodiment of the present invention shown in FIG. 15 incorporating the switching element shown in FIG. 14. In the following table, “Gr.”=“Grade” and “P.”=“Port”.

TABLE 3

| | | | | | Site 422 | | | | | |
|---|---|---|---|---|---|---|---|---|---|---|
| | Cable Status | | | | Port A | | Port B | | Port C | |
| Case | 1 | 2 | 3a | 3b | 1 | 2 | 1 | 2 | 1 | 2 |
| 1 | Up | Up | Up | Up | Gr.1A | Gr.4A | Gr.2A | Gr.3A | Open | Open |
| 2 | Up | Up | Up | Down | Gr.1A | Gr.4A | Gr.2A | Gr.3A | Open | Open |
| 3 | Up | Up | Down | Up | Gr.1A | Gr.2A | Open | Open | Open | Open |
| 4 | Up | Up | Down | Down | Gr.1A | Gr.2A | Open | Open | Open | Open |
| 5 | Up | Down | Up | Up | Gr.1A | P.C1 | Gr.2A | Gr.3A | P.A2 | Open |
| 6 | Up | Down | Up | Down | Gr.1A | P.C1 | Gr.2A | P.C2 | P.A2 | P.B2 |
| 7 | Up | Down | Down | Up | Gr.1A | P.C1 | Open | Open | P.A2 | Gr.2A |
| 8 | Up | Down | Down | Down | Gr.1A | P.C1 | Open | Open | P.A2 | Open |
| 9 | Down | Up | Up | Up | Open | Open | Gr.2A | Gr.3A | Gr.1A | Open |
| 10 | Down | Up | Up | Down | Open | Open | Gr.2A | P.C2 | Gr.1A | P.B2 |
| 11 | Down | Up | Down | Up | Open | Open | Open | Open | Gr.1A | Gr.2A |
| 12 | Down | Up | Down | Down | Open | Open | Open | Open | Gr.1A | Open |
| 13 | Down | Down | Up | Up | Open | Open | Gr.2A | Gr.1A | Open | Open |
| 14 | Down | Down | Up | Down | Open | Open | P.C1 | Gr.1A | P.B1 | Open |
| 15 | Down | Down | Down | Up | Open | Open | Open | Open | Gr.1A | Open |
| 16 | Down | Down | Down | Down | Open | Open | Open | Open | Open | Open |
| | | | | | Site 424 | | | | | |
| | Cable Status | | | | Port A | | Port B | | Port C | |
| Case | 1 | 2 | 3a | 3b | 1 | 2 | 1 | 2 | 1 | 2 |
| 1 | Up | Up | Up | Up | Gr.1B | Gr.4B | Gr.2B | Gr.3B | Open | Open |
| 2 | Up | Up | Up | Down | Gr.1B | Gr.2B | Open | Open | Open | Open |
| 3 | Up | Up | Down | Up | Gr.1B | Gr.4B | Gr.2B | Gr.3B | Open | Open |
| 4 | Up | Up | Down | Down | Gr.1B | Gr.2B | Open | Open | Open | Open |
| 5 | Up | Down | Up | Up | Open | Open | Gr.2B | Gr.3B | Gr.1B | Open |
| 6 | Up | Down | Up | Down | Open | Open | Open | Open | Gr.1B | Gr.2B |
| 7 | Up | Down | Down | Up | Open | Open | Gr.2B | P.C2 | Gr.1B | P.B2 |
| 8 | Up | Down | Down | Down | Open | Open | Open | Open | Gr.1B | Open |
| 9 | Down | Up | Up | Up | Gr.1B | P.C1 | Gr.2B | Gr.3B | P.A2 | Open |
| 10 | Down | Up | Up | Down | Gr.1B | P.C1 | Open | Open | P.A2 | Gr.2B |
| 11 | Down | Up | Down | Up | Gr.1B | P.C1 | Gr.2B | P.C2 | P.A2 | P.B2 |
| 12 | Down | Up | Down | Down | Gr.1B | P.C1 | Open | Open | P.A2 | Open |
| 13 | Down | Down | Up | Up | Open | Open | Gr.2B | Gr.1B | Open | Open |
| 14 | Down | Down | Up | Down | Open | Open | Open | Open | Gr.1B | Open |
| 15 | Down | Down | Down | Up | Open | Open | P.C1 | Gr.1B | P.B1 | Open |
| 16 | Down | Down | Down | Down | Open | Open | Open | Open | Open | Open |

Table 3 sets forth one possible switching scheme of the switching elements contained in site 422 and site 424. Site 425 and site 427 switching element schemes are symmetric to the site 422 and site 424 switching element schemes and thus have identical Boolean tables. As discussed earlier, each grade is transmitted in two parts, referred to in the table as part A or B (e.g. Grade 1A, Grade 3B, etc.). The status of each cable defines what data is present on what port. “UP” means transmitting data and “DOWN” means a failure state. For example, when all four cables (cable 403 is described as two cables as it is the status of the cable legs that defines the switching) are “UP”, at site 1, Port A is carrying on line 1 Grade 1A and on line 2 Grade 4A, Port B is carrying on line 1 Grade 2A and on line 2 Grade 3A, and Port C line 1 and line 2 are in an “OPEN” state (i.e. not used). At site 2, Port A is carrying on line 1 Grade 1B and on line 2 Grade 4B, Port B is carrying on line 1 Grade 2B and on line 2 Grade 3B, and Port C line 1 and line 2 are in an “OPEN” state. Jumping to case 9 (which is depicted in FIG. 7), when cable 1 (i.e. cable 401) is “DOWN”, in site 1, Port A is “OPEN” since it cannot transmit data, Port B carries its normal Grade 2A and Grade 3A traffic, on line 1 and line 2, respectively, and line 1 of Port 3 is used to switch Grade 1A traffic to site 2. In site 2, Port A carries its normal Grade 1B traffic, and Port B carries its normal Grade 2B and Grade 3B traffic. Port A of site 2 will now be carrying the rerouted Grade 1A traffic from Port C, line 1 of site 1. Finally, the table shows the Port C, line 1 of site 2 is carrying data normally on Port A, line 1 of site 1. With this type of switching it is shown that only a failure of all four cables will result in a failure of Grade 1 traffic. In all other cases all of Grade 1 traffic survives.

A method of installing the present invention as described in the preferred embodiment is also described herein. The sequence of deployment described makes best use of the availability of the higher capacity cable. Table 4 lists the standard bandwidth (“BW”) carried on each cable and the protection schemes available during installation of a communication network according to a preferred embodiment of the present invention.

TABLE 4

| Cable | Band Width (Tbps) | Protection Schemes Offered |
|---|---|---|
| 1 | 5.12 | Unprotected |
| 2 | 5.12 | Ring,BestEffort |
| 3 | 10.24 | Ring, Best Effort, Multigrade |

In the preferred embodiment, the first cable 401 of bandwidth X is laid between site 1 and site 3. Next, the second cable 402, also of bandwidth X, is laid between site 2 and site 4. Finally, the third joined cable 403 of at least bandwidth 2X having four ends is laid between the sites on the two landmasses with one end connecting to each landing site, and also connecting bandwidth X to each landing site. Cable 403 is installed so that data is transmitted between sites 1 and 3, and transmitted between sites 2 and 4. Cable 403 can also be connected so that data is transmitted between site 1 and site 4, and transmitted between site 2 and site 3.

While a preferred embodiment of the present invention has been shown and described in the context of a transoceanic cable, those of ordinary skill in the art will recognize that the present invention may be applied to achieving reliable communications through any form of information cable across a span where the cables are not readily accessible and it is impractical or impossible to employ intermediate sites to act upon the information traffic to improve robustness. Furthermore, even though a single direction of communications has been shown for clarity, those of ordinary skill in the relevant art will readily recognize that the present invention may achieve reliable bi-directional communications between two regions with little to no adaptation beyond what has already been taught. The present invention should not be construed to be limited by aspects of the embodiments used for illustrative purposes above, but instead should be bound only the claims that follow.

What is claimed is:

1. A system for communicating between a first region having a first site and a second site, and a second region having a third site and a fourth site, the system comprising:
a first cable having two ends, the first end terminating at the first site and the second end terminating at the third site;
a second cable having two ends, the first end terminating at the second site and the second end terminating at the fourth site; and
a third cable having four ends, the first end terminating at the first site, the second end terminating at the third site, the third end terminating at the second site, and the fourth end terminating at the fourth site;
wherein the first and second cable each have a capacity of bandwidth X and the third cable has a capacity of at least bandwidth 2X.

2. The system of claim 1, wherein data is communicated in the third cable between the first site and the third site, and between the second site and the fourth site.

3. The system of claim 1, wherein the third cable is comprised of two cables of equal capacity.

4. The system of claim 1, further comprising at least one switching element located at each site for switching data traffic between the sites.

5. The system of claim 4, wherein the data traffic is classified into grades having different levels of priority.

6. The system of claim 5, wherein upon the failure of at least one cable the highest priority of the grades of data is switched by a switching element that is located at a site at which the data originates, from the failed cable to one of the other remaining cables, and is transmitted first, followed by successive lower priority grades of data and continuing until a total bandwidth of the remaining cables of the system is utilized.

7. A method of installing a system for communicating between a first region having a first site and a second site connected to each other, and a second region having a third site and a fourth site connected to each other, the method consisting of the steps of:
installing a first cable having a capacity of bandwidth X between the first site and third site;
installing a second cable having a capacity of bandwidth X between the second site and the fourth site; and
installing a third cable having a capacity of at least bandwidth 2X between the first site and the third site and the second site and the fourth site, wherein each site is connected to a bandwidth capacity of at least X.

8. The method of claim 7, wherein the first cable has two ends, the second cable has two ends, and the third cable has four ends.

9. A system for communicating data classified into a plurality of grades between a first region having a first and a second site, and a second region having a third and a fourth site, the system comprising:
a switching element located at each site, each switching element having at least three data ports for transmitting data to the other switching elements, each of a first and a second data port being multiplexed to at least two of the plurality of grades of data, and a third data port being multiplexed to the plurality of grades of data;
a first interconnecting cable being connected to the third data port of a first switching element located at the first site and the third data port of a second switching element located at the second site, and a second interconnecting cable being connected to the third data port of a third switching element located at the third site and the third data port of a fourth switching element located at the fourth site; and
a first cable and a second cable, each being of bandwidth X, the first cable being connected to one of the first and second data ports of the first switching element and one of the first and second data ports of the third switching element, the second cable being connected to one of the first and second data ports of the second switching element and one of the first and second data ports of the fourth switching element, and a third cable of at least bandwidth 2X and being connected to one of the first and second data ports of each switching element, each cable being distantly routed from each other cable.

10. The system of claim 9, wherein the classification of the grades of data is determined by a priority of the grades of data, a lower priority being preempted by a higher priority, the highest priority assigned to a grade of data never preempted and a lowest priority assigned to a grade of data preempted first.

11. In a system for communicating data classified into a plurality of grades between a first region having a first and a second site, and a second region having a third and a fourth site, the system having a first interconnecting cable being connected to the first site and to the second site, a second interconnecting cable being connected to the third site and to the fourth site, a first cable of bandwidth X being connected to the first site and the third site, a second cable of bandwidth X being connected to the second site and the fourth site, and a third cable of at least bandwidth 2X being connected to each of the sites, the improvement which comprises:
a switching element located at each site, each switching element having an input port for each of the plurality of grades of data, and at least three data ports for connecting to switching elements of other sites, a first and a second of the at least three data ports each being multiplexed to at least two of the plurality of grades of traffic, and a third of the at least three data ports being multiplexed to the plurality of grades of traffic.

12. A method of switching a plurality of grades of data in a communications network in the event of at least one data cable failure in the network, the communications network having a first region having a first site connected to a second site, and a second region having a third site connected to a fourth site, each site having at least one switching element, each switching element having a plurality of input ports each being connected to one of the plurality of grades of data, and having at least three data ports for switching data to another of the switching elements, a first and a second data port of the at least three data ports being multiplexed to at least two of the plurality of grades of data and a third data port being multiplexed to the plurality of grades of data, a first cable of bandwidth X being connected to one of the first and second data ports of the first switching element and one of the first and second data ports of the third switching element, a second cable of bandwidth X being connected to one of the first and second data ports of the second switching element and one of the first and second data ports of the fourth switching element, and a third cable of at least bandwidth 2X being connected to one of the first and second data ports of the first and second switching elements and one of the first and second data ports of the third and fourth switching elements, each grade of data being assigned a priority, the method comprising the steps of:
determining that a cable failure has occurred in at least one of the cables; and
switching a higher priority grade of data from the failed cable to a cable not experiencing a failure by preempting a lower priority grade of traffic.

13. A method of switching a plurality of grades of data in a communications network in the event of at least one data cable failure in the network, the communications network having a first region having a first site connected to a second site, and a second region having a third site connected to a fourth site, each site having at least one switching element having at least three data ports for switching data to another of the switching elements, a first cable of bandwidth X being connected to one of a first and a second data port of a first switching element and one of a first and a second data port of a third switching element, a second cable of bandwidth X being connected to one of a first and a second data port of a second switching element and one of a first and a second data port of a fourth switching element, and a third cable of at least bandwidth 2X being connected to one of the first and second data ports of the first and second switching elements and one of the first and second data ports of the third and fourth switching elements, the method comprising the steps of:
multiplexing by the switching elements the plurality of grades of data onto the data ports, with at least two of the plurality of grades of data being multiplexed to each first and second data port, and each grade of data being multiplexed onto each third data port;
assigning a priority to each grade of data;
determining that a cable failure has occurred in at least one of the cables; and
switching a higher priority grade of data from the failed cable to a cable not experiencing a failure by preempting a lower priority grade of traffic, wherein a highest priority of the grades of data is transmitted first, followed by successive lower priority grades of data and continuing until a total bandwidth of the remaining cables of the system is utilized.
